(19) United States
(12) Patent Application Publication
(10) Pub. No.: US 2005/0102703 A1
(43) Pub. Date: May 12, 2005

(54) ON DEMAND BROADCAST INFORMATION DISTRIBUTION SYSTEM AND METHOD

(75) Inventors: Masoud Querashi, Ocean Twp., NJ (US); Majid A. Syed, Princeton, NJ (US)

Correspondence Address: Majid A. Syed, 97 York Dr., Princeton, NJ, 08540, US

(73) Assignees: Mr. Masoud Qurashi, Ocean Twp., NJ (US); Dr. Majid A. Syed, Princeton, NJ (US)

(21) Appl. No.: 10/605,985

(22) Filed: Nov. 12, 2003

(51) Int. Cl. H04N 7/173; H04N 7/16

(52) U.S. Cl. 725/117; 725/116; 725/118; 725/147

(57) ABSTRACT

Current radio broadcast stations have limited geographic coverage. We provide system and method to access real-time world broadcast radio transmission. The system is capable of creating a simplex conference bridge with the desired destination radio station either upon demand by the subscriber or auto scheduled by the system as programmed by the subscriber. The concept is expanded to retrieve commercial promotional multimedia clips of advertisers either upon demand by the subscriber or as if pre-initialized by the subscriber, the system sends alert when such promotion occurs. We find good use of these features during free allocated time by carrier access operators.

### CROSS REFERENCE TO RELATED APPLICATIONS

Not Applicable

### FEDERAL RESEARCH STATEMENT

Not Applicable

### BACKGROUND OF INVENTION

The present invention is related to media broadcast systems and in particular methods and apparatus for accessing on demand broadcast transmission over bi-directional consumer electronics devices.

### SUMMARY OF INVENTION

The novelty allows the user to listen to world broadcast information real-time and is no longer restricted to his existing simplex receiver tuning capability. We propose a system and method, where upon demand a caller can listen to any real-time AM/FM broadcast transmissions without geographic boundary limits of AM/FM transmissions. Additionally, services such as streaming multimedia data are also provisioned. On demand, the caller communicates with a main server over communication network. The call is answered, parked or camped with a call back feature activated. The main server interrogates subscriber billing center and retrieves caller and called service profile. If allowed, the main server initiates a request for a web radio or a point-to-point connection to the desired service station or routes the call to a commercial server. If the caller request for some talk show aired over a digital TV channel, the main server extracts audio bits from the MPEG stream and converts it to wave format. When the main server and the requested service station are connected, the main server creates a simplex conference bridge with the caller. The station data contents are therefore tunneled to the customer duplex device. If the subscriber is pre-registered, the main server can alert the subscriber when his desired transmission is on the air. Also, the main server can be instructed on the fly by the subscriber for other service stations by using (a) dtmf tones with state/country prefix, (b) using standard broadcast station call letters as allocated by world standard bodies, (c) or advanced speech-to-text. The invention therefore allows real-time streaming and or non real-time retrieving broadcast information of interest to subscriber duplex terminal device(s). The invention allows the caller to make effective use of unlimited usage perk as advertised by the carriers.

### BRIEF DESCRIPTION OF DRAWINGS

FIG. 1 Illustrate End-to-End System Architecture of real-time On Demand Information Access System.

FIG. 2 Illustrate Point-2-Point Architecture of real-time On Demand World FM/AM Radio Information Access System.

FIG. 3 Illustrate Web Radio Architecture of real-time On Demand World FM/AM Radio Information Access System.

FIG. 4 Web Architecture of real-time On Demand Commercial Information Access System.

FIG. 5 Illustrate Web Radio Architecture of real-time On Demand TV Audio Information Access System.

FIG. 6 Illustrate Functional Components of Main Server.

FIG. 7 Illustrate Message Signaling for Camping and Conference Join between Caller and Main Server for Access to World Broadcast over Web.

FIG. 8 Illustrate Message Signaling for Camping and Conference Join between Caller and Main Server for Access to World Broadcast over Point-2-Point Link.

FIG. 9 Illustrate Message Signaling for Camping and Conference Join between Caller and Main Server for Access to Commercial Advertisement over Switched Network.

### DETAILED DESCRIPTION

### Prior Art

As noted, the sponsor of a broadcast information is interested in selling his information to a general public with the intent to capture target audiences i.e. sponsor's interest first, followed by the listener interest. As the information terminates on all the receivers, not all of listeners are interested in the broadcast information. Instead, it is desired by the listener to get only the information to which they are interested in listening. In U.S. Pat. No. 6,588,015 a digital radio broadcast system provides various interactive features, such as skip commercials, including skip forward and skip backward. However, the listener is limited to pick from the local station choices to which it can tune. Another drawback is the disclosed art is not applicable to analogue AM/FM transmission. In U.S. Pat. No. 6,463,469 a radio reception system is combined with a computer system. The radio receiver is configured to receive analog FM signals and linked data transmitted according to at least one of the RDS and MBS standards. The data serves as a data trigger to provide the user with a prompt on the computer system. By using RDS, the user can filter information from off-the-air transmission which his receiver can capture i.e. listener is limited to local FM transmissions only. In U.S. Pat. No. 6,230,325 the invention is to provide an information network system and a broadcasting receiving user terminal by which bi-directional communication can be established between a user terminal and a data base center so that a user can enjoy a services provided from the data base center under the guidance broadcast in a broadcasting program and can thus enjoy various services making use of the network. In this claim, geographic limit is increased from local receive to more area coverage, but still the listener is limited to pick from the services offered by the database server and not his requested choice which may not be offered by the database. In U.S. Pat. No. 6,163,683 limited geographic broadcast coverage is increased by making reuse of frequencies by subdividing the range into multiple smaller areas or locales served by separate broadcast transmitters (towers), and reusing allotted frequency spectra in non-adjacent areas. A feature of this invention is that receivers entering a cell area can be tuned to receive or play program information of general interest (e.g. selections of classical music) interspersed with advertisements or announcements of locally specific context. In this claim, beside complexity of implementation an additional tuner is required in the receiving devices. It also has the limitation that the listener desired information might have reachability limits. In U.S. Pat. No. 5,724,650 a radio receiver capable of receiving worldwide short wave broadcasting programs is constructed of a phase-locked loop circuit, a standard time generating circuit, a memory, a timer unit, and a controller. In this claim the same is difficult to do for FM transmissions beside one need an additional tuner in the mobile and pots. In U.S. Pat. No. 5,457,739 an access management and recording reception center is designed to pick up the transmissions broadcast by all these sources, record them and retransmit them on the telephone to subscribers, upon calls from these subscribers, in doing so through the switched telephone network, and providing forward run, back run, pause and restart functions. In this claim the broadcast information is first stored, and is retrieved using switched network. The claim therefore does not cover real-time broadcast over switched network and packet networks, and non real-time broadcast over a packet network. Hence there is a need to provide a mechanism to allow the listener to have access to live real-time broadcast information such as news around the globe of his choice and not what he is forced to listen because of the limitations of the existing radio receiver art devices. Existing terrestrial AM and FM broadcast transmissions as well as HDTV transmissions have geographic limits for its coverage. The modulated radio signal, when transmitted at an allowable power, decays with respect to the distance. Radio receivers are sensitive to the received signal strength. The listener is generally interested in noise free tuned radio frequency. If the distance is large, the signal strength is not enough for the receiver to demodulate the signal and tune to get the broadcast contents. To increase the broadcast coverage, repeaters may be installed. Another technique is to network the radio stations, which increases the coverage from local footprint to national footprint. The drawback in these schemes are that the radio listener is limited to broadcast sponsor contents. If the listener, while sitting in North America, desires to listen to say radio Australia or radio BBC or radio Pakistan chances are his receiver will not pick FM transmission and may pick sporadic AM transmission with quality at its minimum. The present invention proposes a solution where a native with his location in international can listen to a native live radio broadcast of any radio station of the world in real-time. The invention is expanded to retrieving non real-time promotional advertisement multimedia clips on demand. For example, the subscriber may subscribe to service that if traffic alert of his defined route occurs, the commercial server should inform the subscriber of the said event. Similarly, if the subscriber wish to find if a promotional offer for pizza lunch is in place, it may call a local server, which has kept such information. In summary issued prior art, information broadcast filtering mechanism is discussed and is noted to be limited to only local transmitting stations. None of the prior art discuss access to broadcast information as is or filtered beyond the geographic limits of the transmitting station. Therefore, it is the intention of this invention to propose system and method which allows the subscriber to have access to broadcast information of subscriber choice on his duplex devices.

### DESCRITION OF THE PREFERRED EMBODIMENT

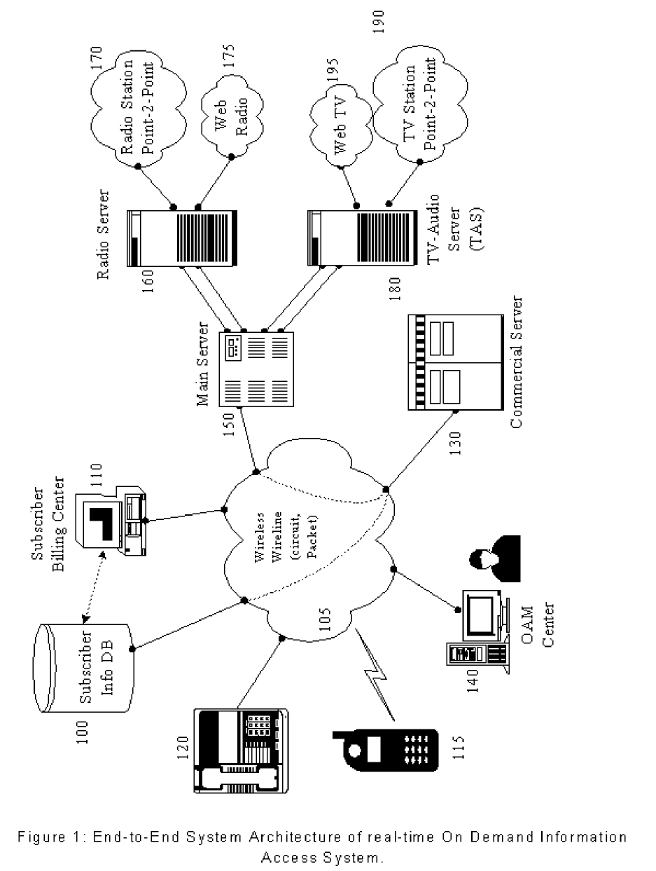

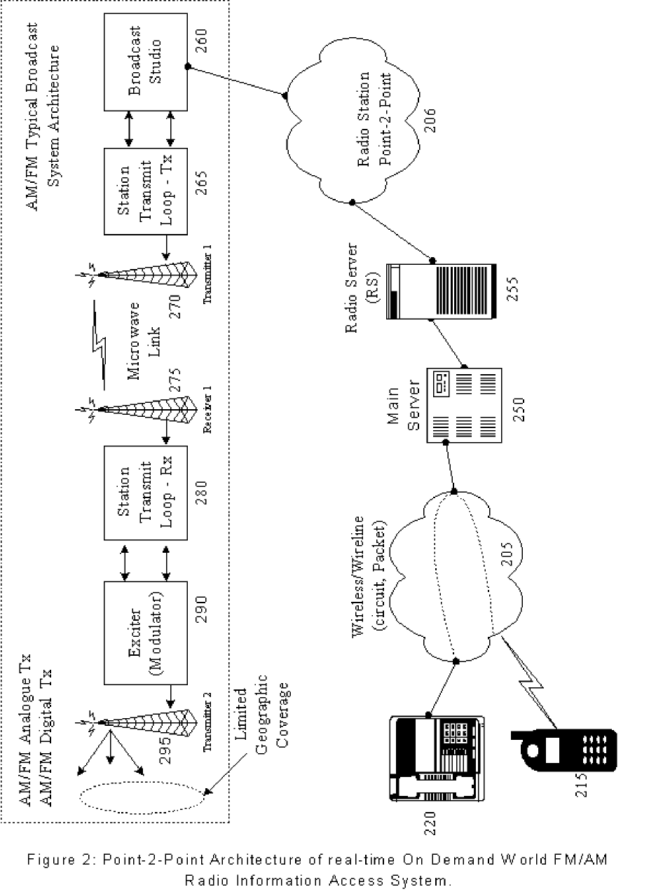

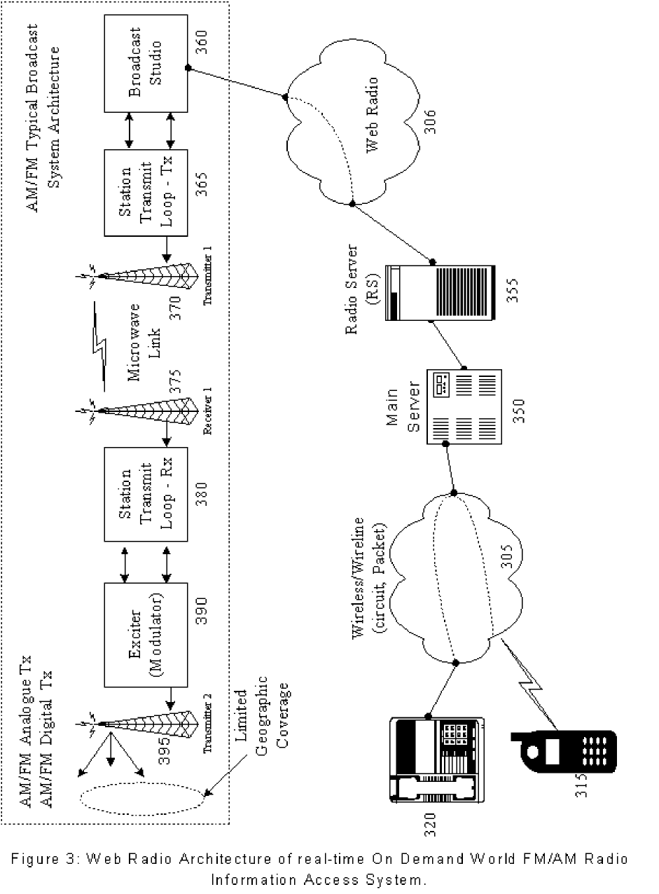

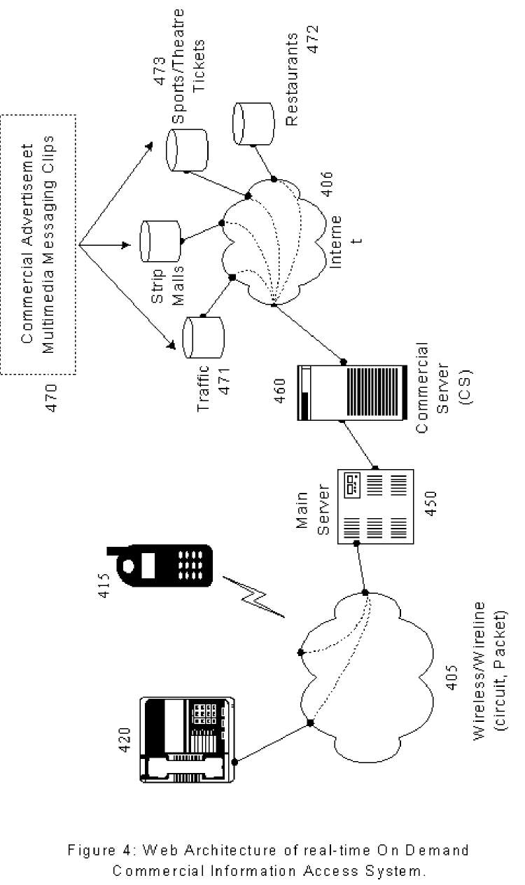

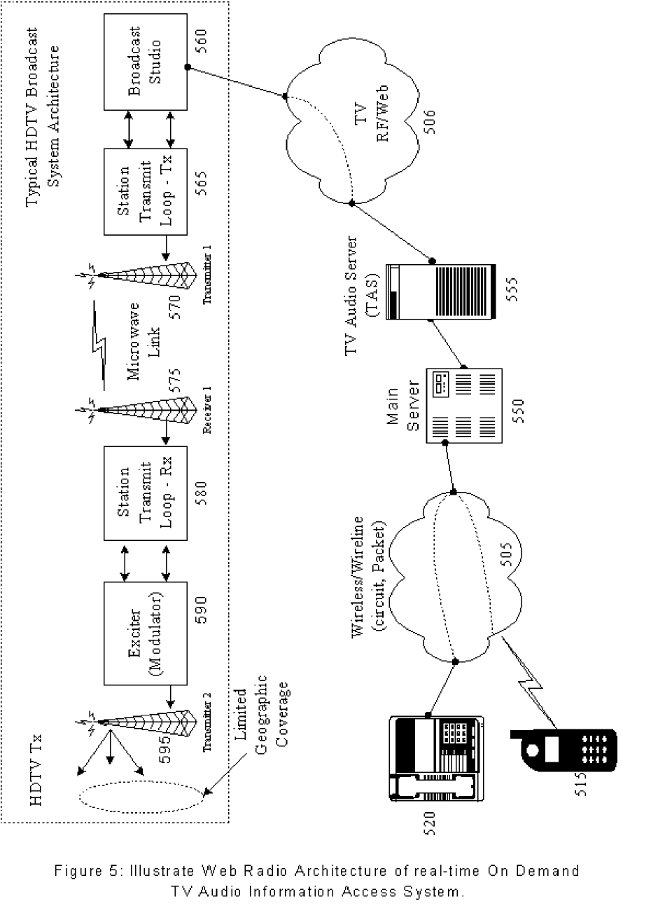

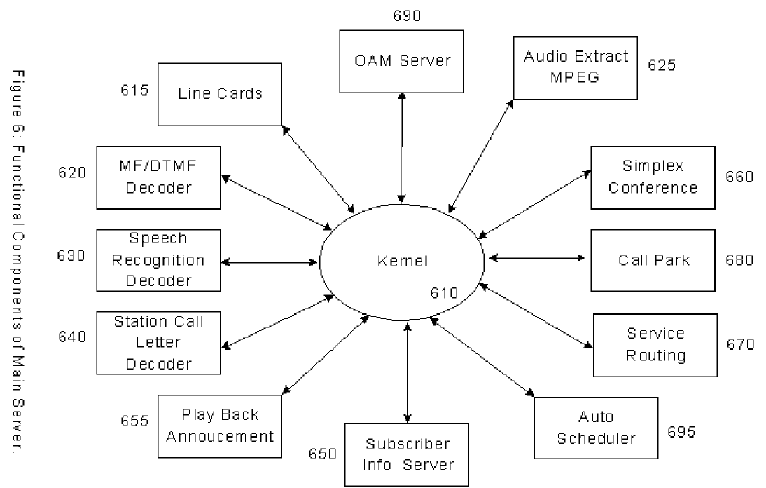

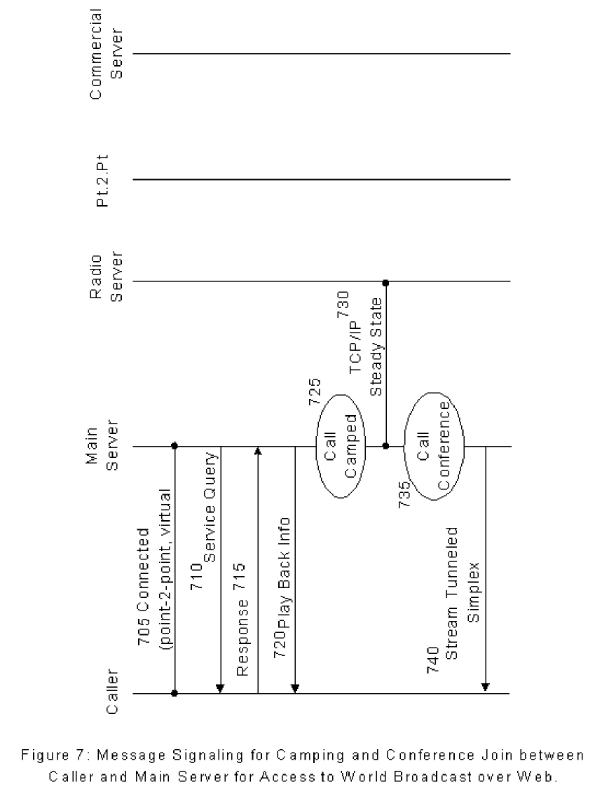

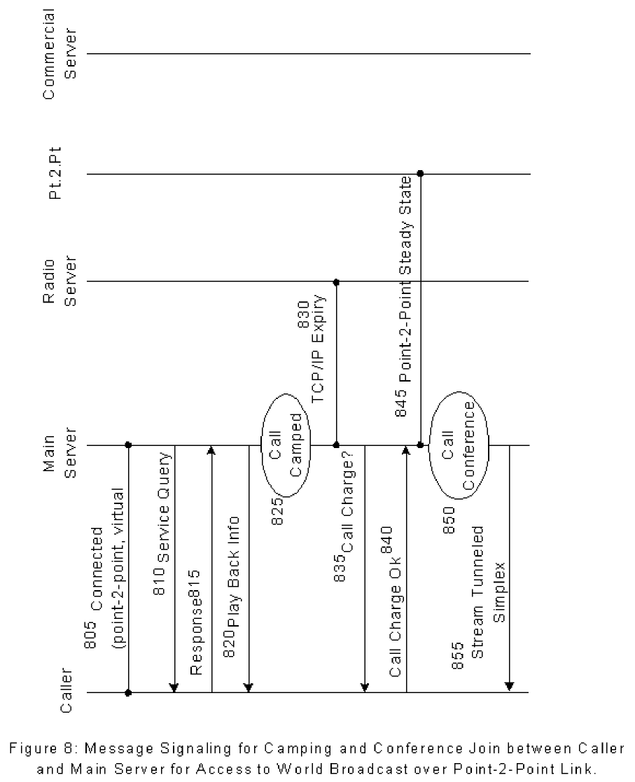

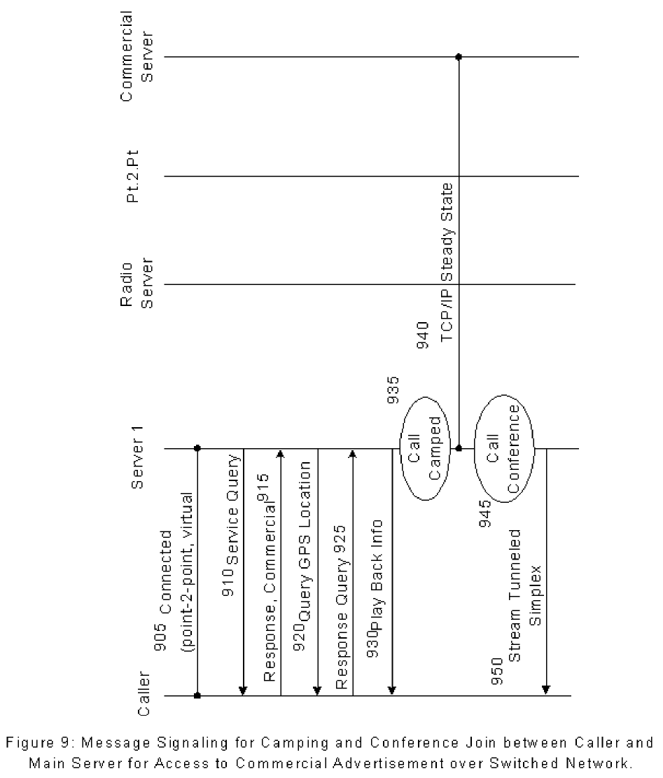

The following description is presented for the purposes of illustration and description. It is not intended to be exhaustive or to limit the invention to exemplary embodiments disclosed. Many modifications and variations are possible in the light of following teachings. It is intended that the scope of the invention be limited not by this detailed description of exemplary embodiments, but rather by the novelty conception. Reference FIG. 1. Customer access device like mobile cell phone 115, or a fixed access device 120 like a POTS initiates a circuit or a packet connection over circuit or packet network 105 respectively to a main server 150 which is equipped with various functions as explained in FIG. 2. Before the call is answered, the main server make use of caller ID and query the subscriber billing server 110 and request for service profile. If prior registered, the subscriber-billing server provides caller subscriber profile. If not, the main server 150 playback a recording asking the caller 115/120 to enter his desired service quest by using key pad or by speaking. Upon response, the main server decodes the request and determine if service can be provided or to be blocked. If the service can be provided, the call is parked. The main server therefore routes the call either to Radio Station Server 160 communicating with individual radio station over web 175 or point-to-point 170, or to TV Audio Server 180 communicating with web TV 195 or point-2-point 190, or to Commercial Advertisement Server 130 communicating with a public network 105. Element 140 is operation administration and management system (OAM) is required to keep the system running and is well known in the art. Standard signaling messages like SMTP are used for management of the entire system. It is to be noted that the above the foregoing description is for a centralized system. The same can be decentralized either one or all components. Thus the over all system may include one or more servers of type 140,150,130,160,180 and one or more databases of type 100 and other forms of customer access devices. Various method of registration may be used like on-line registration via Internet, off-line registration via some call center attendant. Once registered, the subscriber can change his service profile. The registration procedure and service profile is well known in the art and is the subject of this invention. In FIG. 2, it is shown that the main server 250 has routed the call to Radio server 255 after determining the service operator profile that the preferred mode of communication is over a public link (circuit/packet). The typical elements of a radio station system are studio 260, station transmit loop TX 265, transmitting tower 270, receiving tower 275 (where local loop is not available, microwave links are used), station transmit loop rx 280, giving to exciter 290 which does AM or FM modulation and finally to broadcast transmit tower 295. The geographic range of the transmit tower say around 35-50 miles radius. The service operator of such broadcast therefore cannot provide service listener, which does not come in its transmitted range. The radio server 255 does dial in for studio 260 and broadcast feed is therefore tunneled to circuit/packet call in. Once connected, the radio server 255 communicates with the main server 250. The main server, retrieves the camped call, or calls the caller (as instructed in his subscriber profile) and creates a simplex conference call. If the station is popular, the station 260, radio server 255 and main server 250 are already connected. Therefore any new call means initiating a bridging of simplex conference call. In FIG. 3, another variant of radio station is web radio where the station 360 is has a web service. In such a case, the radio server 355 establishes a connection web radio using well-known TCP/IP sockets. Once connected, the main server 350 is indicated and initiates a conference join with caller 315/320. As shown in FIG. 2 and Figure, the mechanism allows tunneling broadcast radio station contents to the caller. Once joined as conference, any access from calling device 315/320 (similarly 215/220) is blocked i.e. the connection type is changed from Duplex to Simplex. Another variant of the proposed invention is on demand auto triggered by the main server. In such a feature, the subscriber has initialized his service profile, indicating that he/she always want to listen to radio BBC at 7:00 am, 5 PM and on Sundays talk shows transmitted on the TV channel etc. The main radio server, therefore, first connects to the stations as per said profile and then sends an in coming call to the subscriber. It is assumed this is a paid subscription and subscriber has already paid for the connection charges. In FIG. 4, another variant of services provided by the main server is accessing to commercial information aired. For example promotional add as seen advertised in various forms. The content provider 470 (traffic 471, strip malls, sports/theatre tickets 473, and restaurants 472) may record their audio clips, indicating their promotions. This service is best serviced if location id is also submitted with the advertisement. These information is now stored in the commercial server 460. A caller requiring information about promotional ad calls main server 450, which routes the call to commercial server 460. Location ID determination is well known in the art. The main server queries the caller about location identification. If the caller is able to provide his GPS location id, the main server forwards the same to commercial server. Location ID helps in facilitating the search. FIG. 5 is an other variant of similar concept but applied to TV transmissions. Because of bandwidth hogging only audio is transmitted to the caller. Visualize caller is interested in listening to a talk show on a TV. As explained earlier, the main server 550 routs the call to TV Audio Server 555. The elements Broadcast Studio 560, Station transmit loop 565, Transmit tower 570, receive tower 575, station transmit loop 580, TV exciter modulator 590 and finally TV transmitter 595 for coverage is a typical chain of sequence well known in the TV transmission. A special API resident in the 560 allows extraction of audio steams. It is this audio stream which is made available to dial in. The TV Audio Server 555 therefore tunnels the audio information to the main server 550. As said earlier, a simplex conference bridge is now created between the caller and the TV station. Again, audio is said to be communicated because of bandwidth limitation. If bandwidth is available multimedia stream can be tunneled. In FIG. 6 we discuss functional components of a main server 700. The kernel 610 keeps monitoring line cards 615. When an inbound call is detected, caller ID, Name is extracted by making use of well-known TAPI (Telephone Application Programming Interface). The kernel 610 then communicates with the billing server via service routing 670. If the service routing replies back with the caller data profile, the kernel routes the call to service routing. The call is answered. If no profile detected as said above, the kernel connects the speech path with play back module 655 to play message-requesting caller to enter service request. The caller either uses Key Pad or make use of Speech to enter is his request. Because of accuracy, keypad method is preferred. The DTMF decoder 620 provides text entered, similarly if speech is used, speech-to-text 620 are activated, which provides text entered. The text entry is compared with pre-stored station call letters with additional suffix of city, state. For example, by station alias such as BBC, London, UK. Or by standard allocated call letters by FCC to a specific station such WKTU, NY, N.Y. Once request is read and understood, a search is made to determine where to find the service. It can be either local to main server; because of pre-stored or else the search is expanded to web. During this time the call is parked 680 or call back feature is activated, which means that as soon as the search is found, the caller is called. Assuming caller camped, and search is found, the kernel initiates a simplex conference with camped call and station. The broadcast transmission (say BBC world service) is now bridged with caller. Another variant is that the caller has previously initialized his service profile allowing the main server to call the caller when the said station starts broadcasting BBC Hindi Service. In FIG. 7, we explain via message flow for a subscriber requesting to listen to a radio station of his choice. Following existing telephony signaling, caller calls a number, which terminates at Main Server. The call is answered. Caller and main server are now in pont-2-point connected 705 steady state connected state. Assuming absence of subscriber registration, main server issues Service Query 710. The caller Response 715 via keypad or speech-to-text. The main server confirms query response 720 and if accepted by the caller, puts the caller in Camped State 725. It then issues a command to open TCP Socket for the requested web site. Assume web site exists. Once a TCP stead-state 730 is achieved, main server bridges the camped call with the TCP socket. A simplex conference 735 is created between the web and the caller. The web stream can now be tunneled 740 to caller over pre-established circuit/packet call. In FIG. 8, we explain via message flow for a subscriber requesting to listen to a point-2-point radio station of his choice. Following existing telephony signaling, caller calls a number, which terminates at Main Server. The call is answered. Caller and main server are now in pont-2-point connected 805 steady state connected state. Assuming absence of subscriber registration, main server issues Service Query 810. The caller Response 815 via keypad or speech-to-text. The main server confirms query response 820 and if accepted by the caller, puts the caller in Camped State 825. It then issues a command to open TCP Socket for the requested web site. Assume web site does not exist. Once a TCP timer is expired 830, the main server ask the caller for call charge back 740. Once call charge ok 740, main initiates a dial up with the requested station. Again following existing telephony call is connected. The main server and station are now in connected steady state connected state 845. Using fast memory switches, call now is put in the conference stead 750. A simplex conference is created between the web and the caller. The station stream can now be tunneled 855 to caller over pre-established circuit/packet call. In FIG. 9, we explain via message flow for a subscriber requesting to get a commercial audio clip. Depending upon request the services provided might be free or subscription based. For example, traffic info service can be charged, whereas, info on weather, commercial items sale can be free to subscriber. Following existing telephony signaling, caller calls a number, which terminates at Main Server. The call is answered. Caller and main server are now in pont-2-point connected 905 steady state connected state. Assuming absence of subscriber registration, main server issues Service Query 910. The caller Response 915 via keypad or speech-to-text. The main server identifying the incoming response for commercial request issues a message 920 to determine the GPS location of the caller. This information is desired, because for some commercial types, call may need to be routed to proper commercial server serving the are. The call response back 925. This assumes that the device has GPS receiver and appropriate open signaling interface installed. The main server confirms the geographic location in terms of street and township name. The caller is then put in the camped state 945. The main server, tries to establish a steady state TCP connection say with the Traffic server and plays back the traffic based upon around some miles of radius with respect to GPS location. Once a TCP stead-state 940 is achieved, main server bridges the camped call with the TCP socket. A simplex conference 945 is created between the web and the caller. The web stream can now be tunneled 950 to caller over pre-established circuit/packet call.

1. A system and method to access real-time broadcast information by a communicating access device communicating with main server A over a switched network, the method comprising the steps of: Server A local repository is initialized with world broadcast stations fixed data e.g. call letters, RF allocation, Station Alias, GPS coordinates etc. Caller and server A are steady state connected over duplex Said caller speaks desired service request station call letters, city, state and country or enters the same by keypad Said server A, camps the said caller Said server A decodes received service request or via speech to text decoding or via DTMF decoding Said server A using the said decoded message pulls pre-stored information the ip address, or telephone number from its local repository about the desired service provider Said server A, making use of the said information initiates a web connection as a default Said server A when in switched steady-state with the said service provider initiates a simplex conference with the said camped caller.

2. Said server of claim 1 may use camp call back feature.

3. Said caller of claim 1, may pre-register his request and enable auto schedule call to the desired service provider with charge back feature authorized.

4. Said server A of claim 3, initiates, maintains and terminates the simplex conference for predetermined time and duration.

5. A method to extract audio bits from digital TV broadcast using standard multimedia coding schemes.

6. Said service request of claim 1, can be to a digital TV broadcast, using method of as said in 5 for tunneling TV audio over said simplex conference with said caller of claim 1.

7. A method to record, playback, add, change, delete an audio or a multimedia short clip, when accessed by a communicating device over a switched network to a commercial server B.

8. A method to access real-time broadcast information to a pre-recorded commercial clip by a communicating access device communicating with the main commercial server B over a switched network, the method comprising the steps of: establishing a steady-state switched connection with the commercial server B. Using interactive dialogue response said server B narrows said caller request say restaurants to menu to cheese to Pizza Server B camps the caller Sever B decodes the received service request by said caller Server B retrieves from its local repository a pre-stored promotional commercial clip like 20% off with this id as said in 7 Server B, retrieves camped call and initiates a simplex conference bridge

9. Said server B of claim 8 may use camp call back feature.

10. Said caller of claim 8, may pre-register his request with his own defined promotion alert and enable auto schedule call to when such a promotion is entered with said server B by a promoter say a companion ticket free.

11. Said server B of claim 8, initiates, maintains and terminates the simplex conference for predetermined time and duration.

12. An article of manufacture comprising a computer usable medium having a compute readable program code embodied therein that receives data content, said data content sent from a subscriber communicating device via a network, wherein said network is Public/and or Private, Switched/and or Packet, Wired/Wireless/Satellite/and or Digital Broadcast Networks, b. computer readable program code parsing said content to extract data content based upon said source station information; c. computer readable program code identifying a server discovery for which said extracted data content is to be routed; d. computer readable program code performing actions as instructed by the service gateway.
